(19) United States
(12) Patent Application Publication
(10) Pub. No.: US 2007/0010766 A1
(43) Pub. Date: Jan. 11, 2007

(54) Massaging device

(76) Inventors: Eckstein Gil, Hashron (IL); Moshe Rint, Holon (IL)

Correspondence Address: Daniel J Swirsky;AlphaPatent Associates, 55 Reuven St, Beit Shemesh, 99544, IL

(21) Appl. No.: 10/554,547

(22) PCT Filed: Apr. 29, 2004
(86) PCT No.: PCT/IL04/00359

§ 371 Date: Sep. 18, 2006

(30) Foreign Application Priority Data
Apr. 29, 2003 (IL) 155639

(51) Int. Cl. A61H 9/00

(52) U.S. Cl. 601/96

(57) ABSTRACT

The present invention presents a thorny mosaic-like, fluid pressurized, massaging article characterized by a planar mosaic matrix; said matrix comprising at least one multiple typical arrangement, whereat a massaging thistle is surrounded by a plurality of either a fluid or gas conduits, in the manner while the fluid pressure is decreased in at least one conduit, the pressure in at least one other adjacent conduit is increased so the central massaging thistle is forced to incline either towards said pressurized or depressurized conduit and vice versa. The present invention also presents a massager useful for massaging the body comprising a flexible flat liquid container; wherein said liquid are adapted to flow repetitively inside said container in a predetermined course; and a plurality of massaging member comprising a proximal finger-like end and a distal flag-like end, wherein said proximal end is located outside said container and further wherein said distal end is located inside said container so a direct liquid-communication is provided between said flag-like end and at least a portion of the liquid of said container.

### FIELD OF THE INVENTION

The present invention generally relates to a massaging device and more specifically to a thorny mosaic-like massaging article and to a method for using the same. The present invention also relates to a massaging article comprising a fluid pressurized means actuating a plurality of massaging thistles and to a method for a method for massaging the body's mussels or any outer portion of the body, enhancing venous circulation, vascular blood flow and/or for stimulating the lymph system

### BACKGROUND OF THE INVENTION

Many inflated devices have been disclosed in the art for varying the air pressure in selected portions of the device to change the areas of support over a period of time, to improve comfort and blood circulation. Hence, U.S. Pat. No. 4,852,195 to Schuhnm presented a hollow air filed body support cushion comprising a set of cells, wherein the pressure of the air in the cell is ever changing. U.S. Pat. No. 6,358,219 to Arkans disclosed calf compression useful for increase vascular blood flow in the lower extremities of the patient, comprising inflated juxtaposed cells. Similarly, U.S. Pat. No. 6,273,866 to Thomas et al. introduced a cushioning device, adapted to be wrapped releasably around the body part of an individual, comprising a plurality of hollow glands and a plurality of fluids ducts having means to inflate said glands.

Thus, the treatment provided to the patients by the aforementioned prior art relates to the cell-like glands, which inflate or deflate in a predetermined manner. Nevertheless, a useful and effective massage is provided by a means of finger-like members, which rotate in a smooth, secure and pleasant way. Such a thorny mosaic-like, fluid pressurized, massaging article was never described in the art and strongly desired for either medical and pleasure aspects.

### SUMMARY OF THE INVENTION

It is thus a goal for the present invention to provide thorny mosaic-like, fluid pressurized, massaging article characterized by a planar mosaic matrix; said matrix comprising at least one multiple typical arrangement, whereat a massaging thistle is surrounded by a plurality of either a fluid or gas conduits, in the manner while the fluid pressure is decreased in at least one conduit, the pressure in at least one other adjacent conduit is increased so the central massaging thistle is forced to incline either towards said pressurized or depressurized conduit and vice versa. Alternatively or additionally, this thorny mosaic-like, fluid pressurized, massaging article defined above is characterized by a planar mosaic matrix; said matrix comprising at least one multiple typical arrangement, whereat a central massaging thistle is surrounded by a plurality glands, in the manner that while at least one gland is deflated, other adjacent glands are inflated so the central massaging thistle is forced to incline towards said deflated gland.

It is yet another goal for the present invention to provide a method for massaging the body's mussels or any outer portion of the body and/or for enhancing venous circulation, vascular blood flow and/or for stimulating the lymph system by applying massaging means of the thorny mosaic-like, fluid pressurized article as defined above.

### BRIEF DESCRIPTION OF THE FIGURES

In order to understand the invention and to see how it may be carried out in practice, a preferred embodiment will now be described, by way of non-limiting example only, with reference to the accompanying drawings, in which:

FIG. 1 schematically illustrates three views of a top view of the aforementioned thorny mosaic-like, fluid pressurized, massaging article according to one embodiment of the present invention, wherein the central thistle is tilted towards at least one deflated gland; and

FIG. 2 schematically illustrates five views of a lateral cross-section of the aforementioned thorny mosaic-like, fluid pressurized, massaging article according to yet another embodiment of the present invention, wherein the central thistle is tilted towards at least one deflated conduit;

FIG. 3 schematically presenting of a surface massage device, adjustable in size for each part of the body;

FIG. 4 schematically presents the massager according to the present invention in a 3D-view (A) and from a lateral cross-section (B);

FIGS. 5A-5C is schematically presenting active embodiments of the massager according to the present invention from a lateral cross-section view;

FIG. 6 schematically presenting various massaging members according to the present invention in a view taken from their lateral cross-section; and,

FIG. 7 shows acupuncture points to be treated according to one embodiment of the present invention (7A), and three embodiments of using the said massager (7B-7D).

### DETAILED DESCRIPTION OF THE FIGURES

The following description is provided, along all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically a massaging article.

The present invention presents thus a novel thorny mosaic-like, fluid pressurized, massaging article. Said article is characterized by a planar mosaic matrix comprising at least one multiple typical arrangement. Each of said massaging thistle is surrounded by a plurality of either a fluid or gas conduits, in the manner while the fluid pressure is decreased in at least one conduit, the pressure in at least one other adjacent conduit is increased so the central massaging thistle is forced to incline either towards said pressurized or depressurized conduit and vis versa.

Alternatively or additionally, said massaging article is characterized by a planar mosaic matrix, comprising at least one typical arrangement. Each of said typical arrangements includes a central massaging thistle and a plurality of hollow inflatable cell-like glands that surrounds said massaging thistle.

Those glands are interconnected by a network of either a fluid or gas conduits, in the manner that one or more cell-lie glands are deflated, the other adjacent glands are inflated effectively, so the central massaging thistle is forced by the inflated glands to incline towards the deflated glands and vice versa, while the inflated glands are deflated and simultaneously the deflated glands are inflated to a sufficient pressure, the massaging thistle is forced to change its orientation and to incline towards those newly deflated glands.

It is hence according to one embodiment of the present invention wherein the glands are inflated/deflated in a revolving manner, so the central massaging thistle is either continuously or gradually rotates along a circular course. Additionally, or alternatively according to yet another embodiment of the present invention, those glands are inflated/deflated in a crosswise manner, so the central massaging thistle is rotate along a diagonal course.

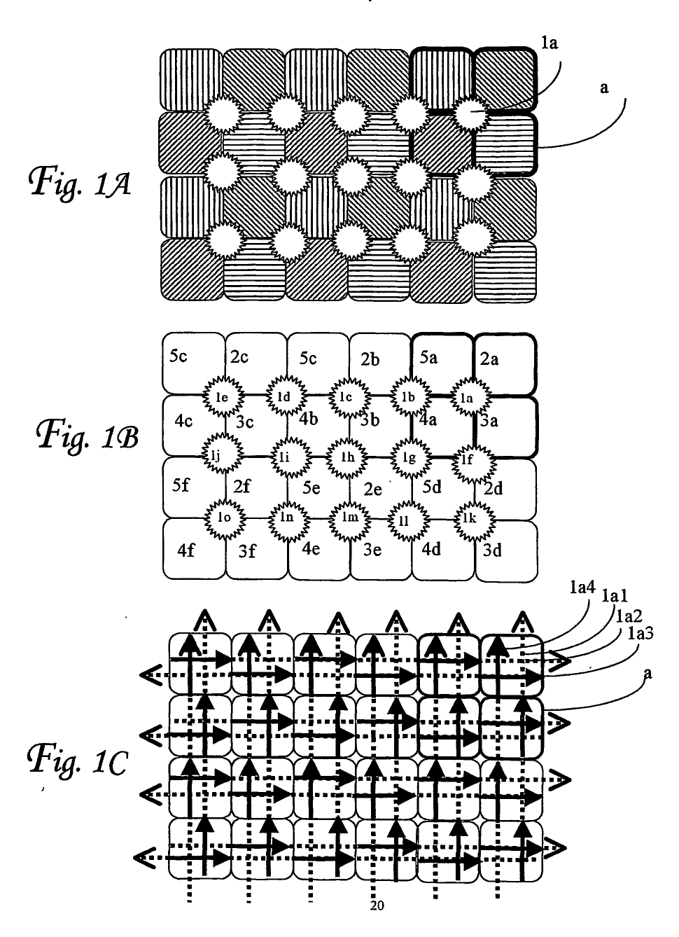

Reference is now made to FIG. 1, in its three subsections A, B and C, presenting a top view of the aforementioned thorny mosaic-like, fluid pressurized, massaging article. View 1A shows a mosaic-like quadrilateral pattern according to one embodiment of the present invention, wherein each of the typical multiple arrangements includes a central massaging thistle (1a) and four hollow inflatable cell-like glands (A) that surrounds said massaging thistle.

The massaging thistle (1a) comprises of at least two portions: head portion facing the outer rim of the massaging article, the surface which is exposed to the user to be massaged, and a stem portion, located in the inner portion of the massaging article, adjacent to the aforementioned gland. The massaging thistle is at least partially hollow and may be connected to the conduit network hereto described.

The nomenclature of each of the aforementioned ingredients of said projected mosaic is presented in view 1B, wherein the hereto defined typical multiple arrangement (A) comprises of gland 2a, 3a, 4a and 5a and the said massaging thistle (1a). Accordingly for example, a neighboring massaging thistle (1b) is surrounded by glands 5a, 4a, 2b and 3b, while another neighbor massaging thistle (1f) is surrounded by glands 3a, 2d, 5d and 4a.

Each of said hollow glands (2a-5f) comprises a plurality of conduits, as described in view 1C. Hence, typical multiple arrangement (A) comprises of a network of conduits, providing at least one gland to remain deflated while other glands are effectively inflated by suitable liquid or gas. It is further acknowledged that the typical arrangement (A) as defined above comprises a central massaging thistle and any number of glands surrounding it. Preferably, a plurality of two to eight adjacent glands is to be used. Thus, only for convenient and for the simplicity of the presentation, a stack of four glands is presented. It is further in the scope of the present invention wherein several arrangements are coexisted in one mosaic.

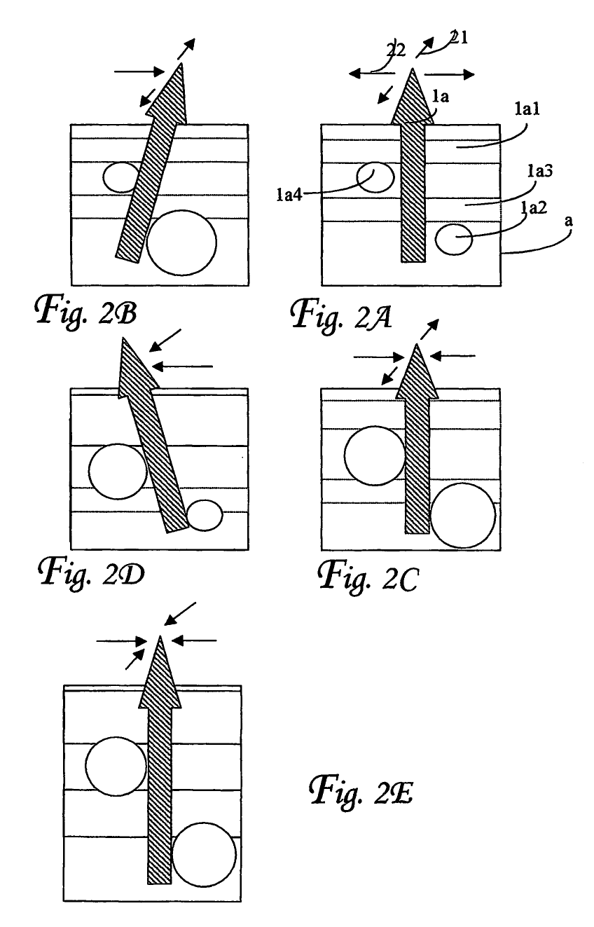

Reference is made now to FIG. 2A-2E, presenting a lateral cross-section of a set of five different variations of the said embodiment of aforementioned typical multiple arrangement (A). Said arrangement (A) comprising a central massaging thistle (1a), which is located in between a plurality of cells-like glands.

Thus, according the first embodiment of the present invention, the predetermined movement is provided by means of deflating at least one gland while most of the other glands are of inflated. According to yet a second embodiment of the present invention, the said movement is provided by a means of a plurality of conduits, located adjacent to the stem of the massaging thistle, in the way the conduit is inflated, its bore size in increasing significantly, forcing the stem portion of the massaging thistle to move backwards, while the its head portion is tilted either backwards and forwards, depends on the anchoring mechanism of the massaging thistle on the proximal portion of the massaging thistle. It is in the scope of the present invention to combine aforementioned first and second embodiments, wherein said combination may be provided in one typical arrangement, or dispersed either randomly or in a predetermined manner along the mosaic matrix of the massaging article.

FIG. 2A schematically illustrates such a lateral cross-section of arrangement (A), wherein no fluid or gas is pressurize throughout conduits 1a1-1a4, so massaging thistle (1a) is free to move either rightwards (21) or leftwards along X axis, forwards (22) or backwards along Z axis or any X-Z combination thereof.

FIG. 2B schematically illustrates another a lateral cross-section of arrangement (A), wherein fluid or gas is pressurize throughout conduits 1a2 alone, so massaging thistle (1a) is forced to move rightwards (21) along X axis, and free to move either forwards (22) or backwards along Z axis or any X-Z combination thereof.

FIG. 2C schematically illustrates another a lateral cross-section of arrangement (A), wherein fluid or gas is pressurize throughout both conduits 1a2 and 1a4, so massaging thistle (1a) is anchored along X axis, and free to move only either forwards (22) or backwards along Z axis.

FIG. 2D schematically illustrates another a lateral cross-section of arrangement (A), wherein fluid or gas is pressurize throughout conduits 1a2, 1a4, and 1a1, so massaging thistle (1a) is forced to move leftwards along X axis and backwards along Z axis.

FIG. 2B schematically illustrates another lateral cross-section of arrangement (A), wherein fluid or gas is pressurize throughout all conduits 1a1-1a4, so massaging thistle (1a) is anchored to its approximated perpendicular orientation in a rigid and non elastic manner.

It is well in the scope of the present invention to provide massaging thistles all variations of movements, so FIGS. 2a-2e are only an example for a much wider scope provided by the present invention, wherein any X-Y-Z orientation is effectively provided by a network of one or more conduits per gland.

It is yet according to another embodiment of the present invention, wherein the massaging thistle and/or the glands are of a wide range of sizes and shapes, and made by either elastic or respectively rigid materials. Those materials are selected, yet not limited to rubber, rubber-like polymers, elastomers, polyurethane derivatives, high-density polyethylene, thermoplastic polymeric compositions or any combination thereof. It is acknowledged that at least a portion of said massaging thistles may comprise metals, preferably in their top portion of in the outer rim, and most preferably magnetic tips, electro-conducting tips etc. Moreover, a fluid of gas conduit is preferably in communication with at least a portion of said massaging thistles, providing a wider scope of movements along Y-axis, rigidity, thermal projection etc.

It is still in the core of the present invention, wherein the fluids or gasses described above are pressurized by pneumatic means, hydraulic means or a combination thereof. Additionally, the massaging article preferably comprises a pressure unit and a control unit adapted to regulate the flow throughout the conduits in a predetermined manner. The pressure unit and the control unit may be selected from many commercial available products, such as described in U.S. Pat. No. 6,415,814.

It is yet according to another embodiment of the present invention, wherein the coronal cross-section of the outer portion of the glands is selected from polygonal, rounded or a combination thereof. Similarly, the outer portion of the conduits is selected from polygonal, rounded or a combination thereof.

It is yet according to another embodiment of the present invention, wherein the fluids inflated the glands are either heated or cooled. The heat exchange may be provided by any commercially available heating/cooling units.

It is yet according to another embodiment of the present invention, wherein the massaging article additionally comprising a pressure unit and/or a control means, useful for regulating either the measure of the fluid pressurized by said pressure unit or the sequence in which the glands or conduits are inflated/deflated.

It is yet according to another embodiment of the present invention, wherein the massaging article additionally comprising vibrating means, preferably wherein the massaging thistle, or the fluids are vibrated in the manner either the glands or the conduits are vibrated.

It is yet according to another embodiment of the present invention, wherein the massaging article is characterized by a predetermined configuration, selected from body support cushion, mattress, base sheet, fluidized bed, warp, sleeve, cuff, compression, or any combination thereof

It is additionally in the scope of the present invention wherein the term ‘massage’ is equally used for any kind of mechanical manipulation or rubbing, especially in the aspect of medical treatment, of the outer surface or internal organs of a patent, including the mussels, blood or lymph circulation, skin, fat layers etc.

The present invention also provided a useful method for massaging the body's mussels or any outer portion of the body by applying massaging means of the thorny mosaic-like, fluid pressurized article as defined in of the above. This method is also useful for enhancing venous circulation, vascular blood flows and/or for stimulating the lymph system by applying massaging means defined and descried above.

It is also in the scope of the present invention to present a massaging device comprising a mattress that is a disposable part; a pump and sonic transducers that may be disposable; and a control unit includes temperature sensor, heating element, electronics, vibrating unit and power supply.

The device according to this embodiment is designed to prevent pressure sores. Such sores appear mostly on the buttocks and the heels of immobile patients who stay in bed for lengthy period of times. A dynamically changing mechanism of the patient supporting structure on the top of the mattress long-time pressure is avoided.

The mattress is a two-layer system. The top layer (Top of FIG. 1 below) is made dense system of many U shape pipes. Each pipe of has two sonic transducers at each ends whose frequency differ by the pulsing frequency (about 1 Hz). The beat frequency drives a set of pressure pulses that produces massage action comfortable to the patient. Such an effect has a soothing feeling as well as stimulating blood flow that is critical for inducing metabolism and healing of tissues.

The bottom part of the mattress (bottom of FIG. 1) contains many square cells each about 4 cm×4 cm creating a “checker board” structure. The cells are linked in an A chain and a B chain. The two chains are interleaved across the mattress area. The cell chains are filled with fluid in an alternating fashion. At one instant all the cells of chain A are filled and support the patient. This duration is about 10 minutes. Following that period the cells on chain B are being filed and support the patient for a subsequent period of 10 minutes. The process repeats itself. The transition period between the two filings is about 3 minutes.

The mattress is made of disposable material that is designed according to the length of the desired use. Temperature control of the mattress fluid will be applied as appropriate for the patient (e.g. for low blood pressure patient relative higher fluid temperature will be used). Except for keeping the patient warm it also has a soothing effect on the patient.

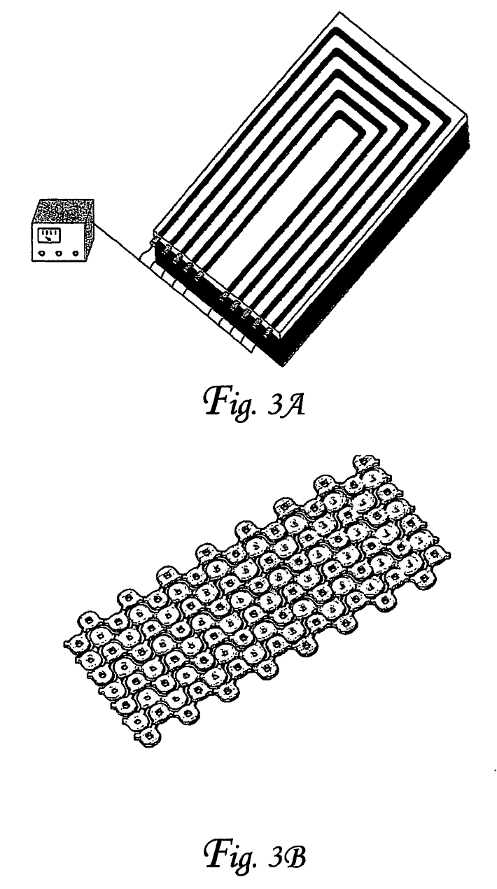

Reference is made to FIG. 3, schematically presenting of a surface massage device, adjustable in size for each part of the body. This device in the form of a two-layer mattress. The top layer contains sound pulse conducting pipes. The bottom layer is a checkerboard-like array of a large number of active cells. Cells work in succession on the body surface. At each instant pressure applied only to a small area (2/4 in a square). Cells are activated by flow of fluid and mechanical control.

It is yet another embodiment of the present invention to present a novel and useful massager, adapted to massage the body. The massager may work actively or passively or any combination of the two. Active means are those that provide the massager to be active: to rotate, to vibrate, and/or to move in a predetermined course without any help from a user. Passive means are those that user is the one who is activating the massager. For example, by moving the body organs, the massager is gained effective measure of kinetic energy to massage said organ

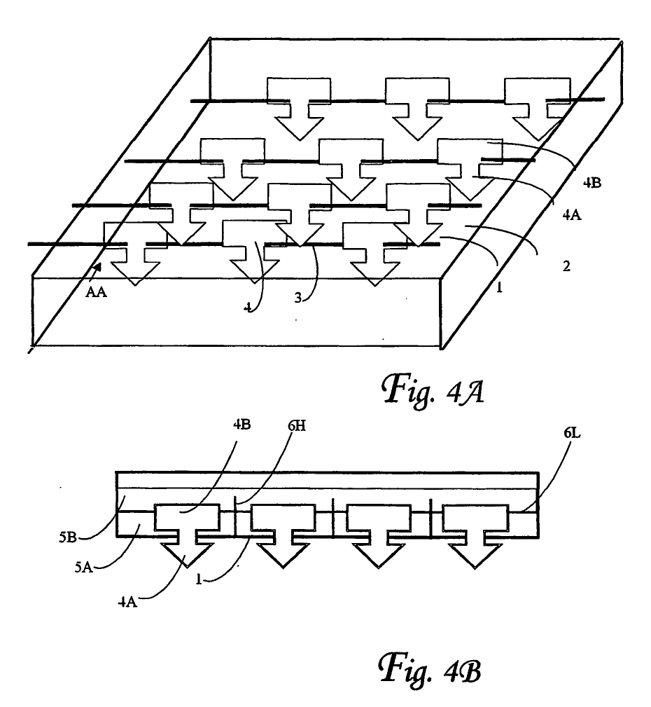

Reference is made now to FIG. 4A is schematically presenting a 3D illustration of the massager according the present invention. Said massager (1) comprising a flexible flat liquid container having a predetermined high (1), length (2) and width (3) as well as a plurality of massaging members (See 4 for example). The liquid accumulated and kept in the container is adapted to flow repetitively inside said container in a predetermined course. The plurality of massaging member is comprises of a proximal finger-like end (4A) and a distal flag-like end (4B). Said proximal end is located outside said container and further wherein said distal end is located inside said container so a direct liquid-communication is provided between said flag-like end and at least a portion of the liquid of said container. The massager is characterized by that the flow of said liquid provides the movement the distal portion of the member, thus enable a gentle massage movement of the proximal finger-like end of the massaging member.

Reference is made now to FIG. 4B, which schematically presents a cross section taken from a side view (AA) of the massager according the present invention. According to this embodiment of the present invention, the aforementioned container comprising two or more liquids (5A and 5B). Said liquids differing by their physical and/or chemical characteristics. Those characteristics are preferably selected from specific gravity, density, hydrophobicity/hydrophylic balance (HLB), composition and/or any mixture thereof. The massaging member is located in its proximal portion (4A) outside the container (1) while its distal portion (4B) in located inside the container, socked in the liquids (5A and/or 5B).

According to another embodiment of the present invention, the aforementioned liquid and/or liquids are selected, yet not limited to water and/or any water miscible solutions, salt solutions of inorganic materials, waterborne liquids, solvents, organic fluids, ethers, alkyls comprising carbon chains of C₅ to C₁₈, haloganted fluids, carbon tetrachloride, emulsions, microemulsions and any mixture thereof.

According to another embodiment of the present invention, the aforementioned container is divided to a plurality of segments; said optional segments provide for liquid flow in a predetermined course and rate. Those segments are preferably selected from longitudinal (6L) and/or lateral segments (6H). Those segments are at least partially dividing the container in the manner flow conduits are enabled.

According to another embodiment of the present invention, the aforementioned massager comprising materials selected from thermoplastic compositions, polyurethane, rubber, polypropylene, polystyrene, cotton or any mixture thereof. Accordingly, the hereto-defined massaging members (4) comprising materials selected from thermoplastic compositions, polyurethane, rubber, polypropylene, polystyrene, metals, magnetic matter or any mixture thereof.

It is well in the scope of the present invention wherein the massager as defined in any of the embodiments mentioned above is comprises of active means to rotate the fluids and/or the massaging members. It is thus according to another embodiment of the present invention, wherein the active means comprising (a) an effective power supply; and (an) activator of any type.

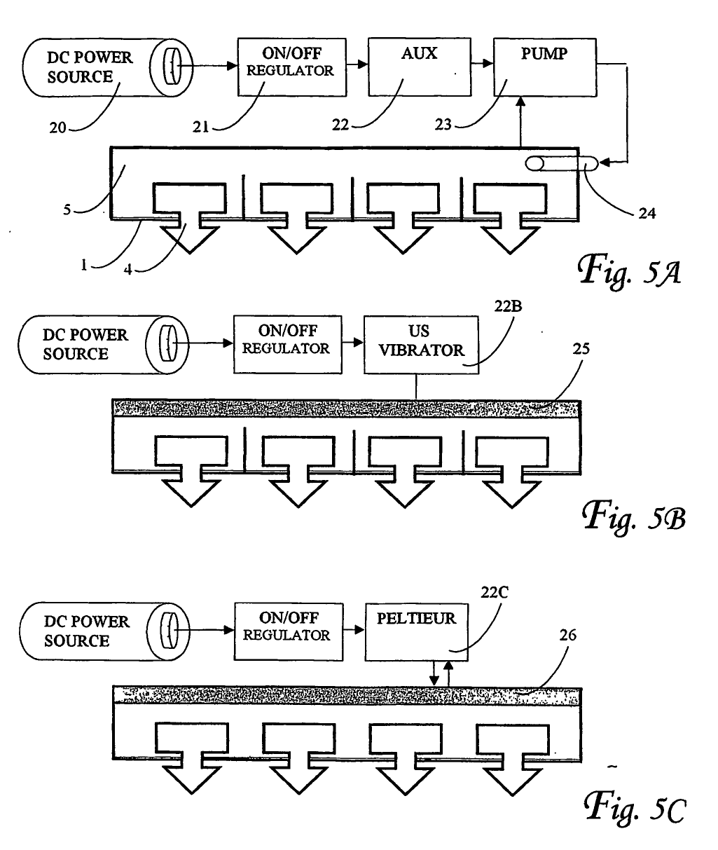

Reference is made now to FIG. 5A, 5B and 5C that are schematically presenting a diagram of the ‘active’ massager according the present invention. In this example, one or more DC battery (20) is connected to a switch and/or regulator (21), which is potentially connected to any accessory (22), and to an activator or vibrator (23).

The aforementioned power supply (20) is preferably selected from at least one DC battery, AC/DC electrical current, vehicle and/or car electrical power and any combination thereof. According to another embodiment of the present invention, the aforementioned activator is a fluid pump. Such a pump is having means to recycle the fluids effectively, so the distal ends of the massaging member shall move in a predetermined course and velocity.

Additionally or alternatively, said activator is a vibrator. Such a vibrator selected from an ultrasound emitter, mechanical vibrator, rotateable engine, a pump or any combination thereof. Said activator is having means to vibrate the fluids effectively, so the distal ends of the massaging member shall move in a predetermined course and velocity.

According to another embodiment of the present invention, the aforementioned massager is additionally comprises of a regulator of any type (21). The said regulator (21) is adapted to switch ON/OFF the activator and/or vibrator and/or additional accessory if exist, or to regulate their action.

According to another embodiment of the present invention, the aforementioned massager is additionally comprises of at least one accessory (22). Said accessory is having means, yet is not limited to those means that are adapted to regulate the temperature of the container and/or massaging members, ventilate the body, release cretin substances and any combination thereof

Reference is made now to FIG. 5A, schematically presenting a diagram of the massager according the present invention. According to this embodiment, the liquids are flowing in the container by means of a pump (23). Many pumps are commercially available and fit to this novel system, such as peristaltic pumps rotor pumps etc. Fluids are recycled from the container (1) to the pump (23) and back to the container via orifice 24. It is acknowledged in this respect that devices 20-23 all or few, may located either adjacent the massager, preferably in a sealed pouch portion near the container, or in any remote location.

Reference is made now to FIG. 5B, schematically presenting a diagram of the massager according the present invention. According to this embodiment, an effective vibrator is appended to the massager. Said vibrator may be selected form a wide range of facilities, all known in the art. Here, an ultrasound emitter is provided (22B) a good example wherein a membrane (25) located in communication to the fluids or the container wall is adapted to vibrate the said fluids and/or the massaging members.

Reference is made now to FIG. 5C, schematically presenting a diagram of the massager according the present invention. According to this embodiment, a heating exchange unit is appended. A cost effective Peltiuer device (25) is effectively radiating heat to the fluids or alternatively, cooling the fluids by means of radiator (26). According the first embodiment, mussels are effectively massaged, and according to the second embodiments, a headache and/or sour wound is to be treated.

According to another embodiment of the present invention, the aforementioned massager is providing useful means to massage body portions. Those organs are selected, yet not limited to the scalp, head, neck and shoulders, all portions of the hands and/or the legs and/or hind parts.

It is also in the scope of the present invention wherein the massager as defined above is adapted to avoid pressure wounds and edemas.

It is still another embodiment of the present invention, wherein the aforementioned massager is characterized by helmet-like, pillow-like, sheet-like arrangements and any combination thereof.

According to another embodiment of the present invention, the aforementioned massager additionally comprising a regulator. Said regulator is adapted to switch ON/OFF the activator and/or vibrator and/or the accessory.

It is further another embodiment of the present invention wherein the proximal portion of the massaging members is smooth or rough to touch. Additionally or alternatively, said members are characterized by a predetermined shape selected from a finger, needle, acupuncture-like needle, saw-tooth, a brush-like teeth, hollow abutment, hair-like pattern, a spatula-like pattern, a metal-ended finger, a magnetic-ended finger or any combination thereof.

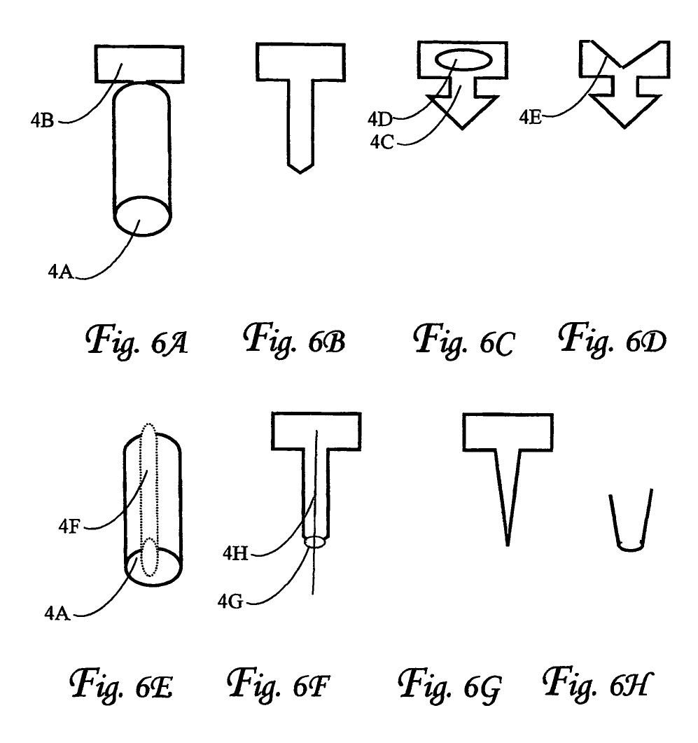

Reference is made now to FIG. 6, schematically presenting a lateral cross section of the massager according the present invention. According to following embodiments, the proximal portion (4A) of the member is characterized by a tubular shape (A), a needle or nail shape (3), drawing-pin shape (C, D). The distal portion (4B) may comprise hollows (C) or wings (D) of all shapes and sizes. The member may be hollow. Accordingly, said hollow members may be adapted to deliver predetermined substances (e.g., lubricants, medicaments, soaps and cosmetics, air, oxygen, ozone etc) from the distal portion (ie., channels located in the container, channels to accessories located outside the massager etc) to the body to be treated. It is acknowledged in this respect that each of those member's arrangements may comprise metals and/or magnets (4G, FIG. 3E). Said metal extensions may be used as emitters, sensors etc. Moreover, a continuous communication is possible between the proximal portion of the member, via line 4H to any device located at the distal rim of the massager. Such an embodiment is suitable perfectly for acupuncture-oriented devices. It is well in the scope of the present invention wherein the massaging members are varied and comprise either sharp (G) or rounded (H) tips.

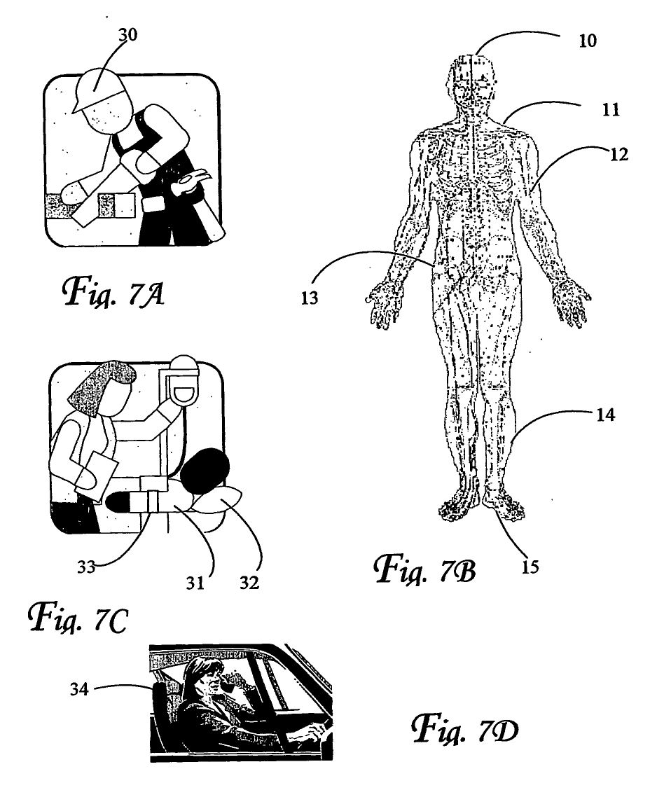

Reference is thus made to FIG. 7A, showing preferred location for using the massager as defined above, especially yet not limited to acupuncture points located at the head (10), shoulders (11), hands (12), abdormal and/or fimural area (13), legs (14 and 15).

The massager according to another embodiment of the present invention is adapted to press the body at predetermined locations by means of the finger-massaging members.

Additionally or alternatively, the massager according to another embodiment of the present invention is adapted to protrude the body surface at predetermined locations by means of needle-like massaging members.

It is in the general scope of the present invention to present a novel and highly useful method for massaging the body by means of the massager as defined in any of the above.

Most preferably, said massager is adapted for massaging the scalp and any other portion of the head by means of a helmet-like massager (See 30, FIG. 7B), as defined above. Moreover, it is according to another embodiment of the present invention to provide a useful method for medically treating the body of humans by means of the said massager as defined above. Said method is especially useful for avoiding pressure wounds, edemas and diabetes wounds.

The present invention is also providing a useful method for medically treating the body of humans by means of the massager as defined above. More specifically, said method is especially useful for avoiding pressure wounds, edemas and diabetes wounds. The method is also useful for treating obesity.

The present invention lastly provided for a useful car seat (See 34 in FIG. 7D), a chair cover, a bad sheet (See 33, FIG. 7C), a mattress, a helmet (See 30, FIG. 7A) and/or sleeve (See 33, FIG. 7C) comprising the massager as defined above.

1. A thorny mosaic-like, fluid pressurized, massaging article characterized by a planar mosaic matrix; said matrix comprising at least one multiple typical arrangement, whereat a massaging thistle is surrounded by a plurality of either a fluid or gas conduits, in the manner while the fluid pressure is decreased in at least one conduit, the pressure in at least one other adjacent conduit is increased so the central massaging thistle is forced to incline either towards said pressurized or depressurized conduit and vice versa.

2. The thorny mosaic-like, fluid pressurized, massaging article according to claim 1, characterized by a planar mosaic matrix; said matrix comprising at least one typical arrangement, whereat a massaging thistle is surrounded by a plurality of hollow inflatable cell-like glands; said glands are interconnected by a network of either a fluid or gas conduits, in the manner while at least one gland in deflated, other adjacent glands are inflated so the central massaging thistle is forced to incline towards said deflated gland and vice versa.

3. The massaging article according to claim 1, wherein the fluids are pressurized by pneumatic means, hydraulic means or a combination thereof.

4. The massaging article according to claim 1, wherein the typical arrangement comprises a central massaging thistle and two to eight adjacent glands.

5. The massaging article according to claim 1, wherein the coronal cross-section of the outer portion of the glands is selected from polygonal, rounded or a combination thereof.

6. The massaging article according to claim 1, wherein the glands are inflated/deflated in a revolving manner, so the central massaging thistle is either continuously or gradually rotate along a circular course.

7. The massaging article according to claim 1, wherein the glands are inflated/deflated in a crosswise manner, so the central massaging thistle is rotate along a diagonal course.

8. The massaging article according to claim 1, wherein fluids inflated the glands are either heated or cooled.

9. The massaging article according to claim 1, additionally comprising vibrating means.

10. The massaging article according to claim 1, additionally comprising a pressure unit and/or a control means useful for regulating either the measure of the fluid pressurized by said pressure unit or the sequence in which the glands or conduits are inflated/deflated.

11. The massaging article as defined in claim 1, characterized by a predetermined configuration, selected from body support cushion, mattress, base sheet, fluidized bed, warp, sleeve, cuff, compression, or any combination thereof.

12. (canceled)

13. A method for massaging the body's mussels or any outer portion of the body by applying massaging means of the thorny mosaic-like, fluid pressurized article as defined in claim 1.

14. A method for enhancing venous circulation, vascular blood flow and/or for stimulating the lymph system by applying massaging means of the thorny mosaic-like, fluid pressurized article as defined in claim 1.

15. A massager useful for massaging the body comprising; a. A flexible flat liquid container; wherein said liquid are adapted to flow repetitively inside said container in a predetermined course; b. A plurality of massaging member comprising a proximal finger-like end and a distal flag-like end, wherein said proximal end is located outside said container and further wherein said distal end is located inside said container so a direct liquid-communication is provided between said flag-like end and at least a portion of the liquid of said container; characterized by that the flow of said liquid provides the movement the distal portion of the member, thus enable a gentle massage movement of the proximal finger-like end of the massaging member.

16. The massager according to claim 1, wherein the container comprising two or more liquids; said liquids are differ by their physical characteristics, selected from specific gravity, density, hydrophobicity/hydrophylic balance, composition and/or any mixture thereof.

17. The massager according to claim 15, wherein liquid and/or liquids are selected from water, salt solutions of inorganic materials, waterborne liquids, solvents, organic fluids, ethers, alkyls comprising carbon chains of C₅ to C₁₈, haloganted fluids, carbon tetrachloride, emulsions, microemulsions and any mixture thereof.

18. The massager according to claim 15, wherein the container is divided to a plurality of segments; said segments provide for a liquids flow in a predetermined course and rate.

19. The massager according to claim 18, wherein the segments are selected from longitudinal and/or lateral segments.

20. The massager according to claim 18, wherein the segments are at least partially dividing the container in the manner now conduits are enabled.

21. The massager according to claim 15, comprising materials selected from thermoplastic compositions, polyurethane, rubber, polypropylene, polystyrene, cotton or any mixture thereof.

22. The massager according to claim 15, wherein the massaging members comprising materials selected from thermoplastic compositions, polyurethane, rubber, polypropylene, polystyrene, metals, magnetic matter or any mixture thereof.

23. The massager according to claim 15, comprising active means to rotate the fluids and/or the massaging members.

24. The massager according to claim 23, wherein the active means comprising ; a. power supply; and b. Activator.

25. The massager according to claim 24, wherein the power supply is selected from an DC battery, AC/DC electrical current, vehicle and/or car electrical power and any combination thereof.

26. The massager according to claim 24, wherein the activator is a fluid pump, having means to recycle the fluids effectively, so the distal ends of the massaging member shall move in a predetermined course and velocity.

27. The massager according to claim 24, wherein the activator is a vibrator, selected from an ultrasound emitter, mechanical vibrator, a pump or any combination thereof said activator is having means to vibrate the fluids effectively, so the distal ends of the massaging member shall move in a predetermined course and velocity.

28. The massager according to claim 24, additionally comprising a regulator; said regulator is adapted to switch ON/OFF the activator and/or vibrator and/or additional accessory if exists, or to regulate their action.

29. The massager according to claim 15, additionally comprising an accessory; said accessory is having means to regulate the temperature of the container and/or massaging members, ventilate the body, release cretin substances and any combination thereof.

30. The massager according to claim 15, adapted to massage body portions selected from scalp, head, neck and shoulders, all portions of the hands and/or the legs and/or hind parts.

31. The massager according to claim 15, adapted to avoid pressure wounds and edemas.

32. The massager according to claim 15, characterized by helmet-like, pillow-like, sheet-like arrangements and any combination thereof.

33. The massager according to claim 24, additionally comprising a regulator; said regulator is adapted to switch ON/OFF the activator and/or vibrator and/or the accessory.

34. The massager according to claim 15, wherein the proximal portion of the massaging members is smooth or rough to touch, and characterized by a predetermined shape selected from a finger, needle, acupuncture-like needle, saw-tooth, a brush-like tooths, hollow abutment, hair-like pattern, a spatula-like pattern, a metal-ended finger, a magnetic-ended finger or any combination thereof.

35. The massager according to claim 15, adapted to press the body at predetermined locations by means of the finger-massaging members.

36. The massager as defined in claim 15, adapted to protrude the body surface at predetermined locations by means of needle-like massaging members.

37. A method of massaging the body by means of the massager as defined in claim 15.

38. The method according to claim 37, useful for massaging the scalp and any other portion of the head by means of a helmet-like massager.

39. A method of medically treating the body of humans by means of the massager as defined in claim 15.

40. The method according to claim 39, useful for avoiding pressure wounds, edemas and diabetes wounds.

41. A car seat, a chair cover, a bad sheet, a mattress, a helmet and/or sleeve comprising the massager as defined in claim 15.
